(19) United States
(12) Patent Application Publication
(10) Pub. No.: US 2016/0098104 A1
(43) Pub. Date: Apr. 7, 2016

(54) USE OF A DEVICE AS AN INPUT DEVICE FOR TOUCH-SENSITIVE, CAPACITIVE SURFACES

(71) Applicant: J.S. STAEDTLER GMBH & CO. KG, Nürnberg (DE)

(72) Inventor: Oliver SCHWAB, Cadolzburg (DE)

(21) Appl. No.: 14/889,259

(22) PCT Filed: Apr. 12, 2014
(86) PCT No.: PCT/EP2014/000984

§ 371 Date: Nov. 5, 2015

(30) Foreign Application Priority Data
May 8, 2013 (DE) 10 2013 008 231.5

(51) Int. Cl. G06F 3/0354; G06F 3/044; G06F 1/16

(52) U.S. Cl. CPC G06F 3/03545; G06F 1/16; G06F 3/044

(57) ABSTRACT

An input device for touch-sensitive, capacitive surfaces, wherein the device includes a holder and at least one application element. The device is formed as a holder filled with a liquid application medium. The holder of the application device is electrically non-conductive, at least in the handle region, and the application medium is electrically conductive. An electrically conductive connection is formed between the at least one application element and the liquid application medium.

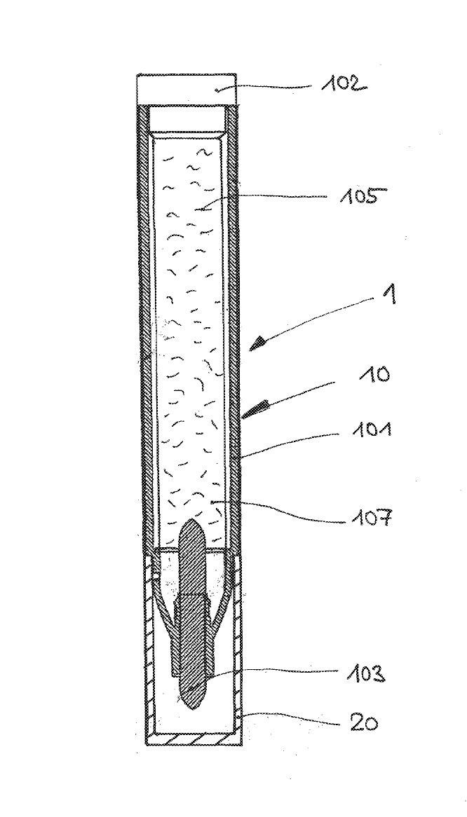

The invention relates to the use of a device as an input device for touch-sensitive, capacitive surfaces, wherein the device is formed as a writing, drawing and/or painting implement filled with an application medium or as a cosmetic implement.

Input devices for surfaces/displays of this type are known in principle.

Thus, for example, input stylus pens are known which consist of an electrically conductive barrel one end of which is provided with a soft, conductive elastic contact head for the display or the surface of the display.

The disadvantage with input styluses of this type is that they are too expensive to use purely as an input stylus and in addition, do not have any writing and/or application functions.

Furthermore, input styluses are known which comprise a writing means or an applicator at one end and at the other end an electrically conductive arrangement in the form of a contact head which allows or initiates an input function when the capacitive display is touched.

However, the known input pens mentioned above suffer from many disadvantages.

Thus, pens of this type are expensive to manufacture since the barrels are conductive, which until now has not been a necessity for conventional application devices. Furthermore, nearly all of such prior art input pens are constructed as ballpoint pens, and so users are very restricted in their choice of writing medium.

US 2008/0266267 A1 discloses an input pen which essentially consists of a pure stylus element. This stylus element is a universal pen which, because of its conductive barrel, functions as an input element, wherein optionally, various indication, application devices and the like can be docked onto this input element, but do not have anything to do with the actual function.

The disadvantage with this solution is that the input pen is expensive to manufacture. In addition, the indication and/or application devices disposed on the input pen can easily be lost.

Thus, the object of the invention is to provide an input device for touch-sensitive capacitive surfaces which do not suffer from the disadvantages mentioned above, wherein the input device also has an application function as well as the input function.

A further object of the invention is to obtain an input function for a known application device without constructional changes.

The term “application devices” as used below should be understood to include writing, drawing and/or painting devices such as felt-tip pens, for example.

This object is accomplished by means of the features of the main claim. Advantageous embodiments are included in the dependent claims.

The device for use in accordance with the invention consists of at least a pen/barrel with at least one application element.

The pen is filled with a liquid application medium, wherein the pen or barrel is not conductive, or at least is not conductive in construction in the user's gripping region. The application medium, on the other hand, is electrically conductive; in this regard, there is an electrically conductive connection between the at least one application element and the liquid application medium inside the pen.

In this regard, it has surprisingly been shown that the device functions as an input device and the surface of the pen of the device does not have to be constructed so as to be electrically conductive.

Examples of non-conductive pens are those with barrels formed from thermoplastic synthetic materials such as polypropylene (PP) or polyethylene (PE).

Furthermore, it has surprisingly been shown that a non-solid substance/application medium, in the present case a liquid substance, is formed as a functional element of the input device.

The liquid application medium may be present as a free liquid in the pen or as a capillary action liquid in a reservoir system.

The liquid application medium in this case may be an ink, drawing ink or colourless erasable or cleaning liquid. In this regard, it is irrelevant whether the application medium is aqueous or non-aqueous. The only important factor for it to function as an input device is that the respective application medium is electrically conductive.

Irrespective of the embodiment of the application medium, it is in fact vital that an electrically conductive connection is formed between the application element provided with the conductive application medium and the application medium stored inside the pen.

The application element is the contacting element at the same time, which contacting element touches the surface of the touch-sensitive capacitive display at the moment of “input”.

In this regard, as with prior art input devices, the application element/contacting element is not formed from a solid or hard material so that the glass-like surface of the display is not damaged or scratched.

The application elements of the present invention are produced from fibres, rubber, foam or sintered synthetic material tips.

The FIGURE below is provided for a better understanding of the solution of the invention.

The FIGURE shows a possible embodiment of a device or input device 1 in which the device 10 is formed as a pen/barrel 101 with an application element 103, a reservoir system 107 and an end stopper 102. The pen 101 or the barrel is closed by a removable end cap 20.

An electrically conductive connection is formed between the tip of the application element 103 and the reservoir system 107 impregnated with electrically conductive application medium 105.

The material of the pen 101 or barrel which usually comprises the gripping region is not electrically conductive.

In the case of using or inputting onto a tablet or display (not shown), the application element contacts the surface of the tablet and thus makes a conductive connection with the reservoir system impregnated with ink, whereupon a charge transfer takes place on the tablet surface and thus an input function is carried out.

Surprisingly, it has now been shown that the “input” function also functions when the pen/barrel is an insulator. In this case, a capacitive element is formed between the user's fingers and the reservoir system, whereupon a charge transfer takes place on the tablet surface and thus an input is successfully entered.

In a variation (not shown), inside the pen (101) there is no reservoir system (107), but the application medium (105) is a free liquid/application medium.

As can be seen in the FIGURE, the application medium must be conductive.

Some examples of formulations which fulfill the criterion of conductivity will now be given.

### Formulation Example 1

### Yellow Text Highlighter in Accordance with DE 43 20 959 C2, Example 8.1

| | | |
|---|---|---|
| Water | 470 | g |
| Lanolin sulphosuccinate | 20 | g |
| Benzisothiazolinone | 2 | g |
| Pentaglycerine | 100-150 | g |
| Basic Yellow 40 (500%) | 6.5 | g |
| Solvent Yellow 43 | 0.5 | g |
| Synthetic material dispersion (40-42%) + | 420 | g |
| further steps for production, | | |
| see DE 43 20 959 C2 | | |

DE 43 20 959 C2 contains many examples of inks which also fulfill the criterion of conductivity and may be used in the input device in accordance with the invention.

### Formulation Example 3

### Red Ink for Fibre-Tip Pen

| | |
|---|---|
| Water | 61.8% by weight |
| Preservative | 0.2% by weight |
| Beeswax | 0.3% by weight |
| Triethanolamine | 0.3% by weight |
| Emulsifying agent | 1.4% by weight |
| Gum Arabic | 0.1% by weight |
| Diethylene glycol | 32.1% by weight |
| Colorant | 3.8% by weight |

Formulation example 3 is known from DE 297 14 594 U1. Reference should be made to formulation examples 1 to 9 in that document for other inks which are also conductive because of their composition.

### Formulation Example 3

### Colourless Alcoholic Erasable Ink

| | |
|---|---|
| Ethyl acetate | 18.0% by weight |
| 1-methoxypropan-2-ol | 24.5% by weight |
| Fluoroalkyl acrylate copolymer | 1.0% by weight |
| Ethoxypropanel | 20.0% by weight |
| Ethanol | 28.5% by weight |
| 1,2-propanol | 14.0% by weight |
| Colorant | 3.8% by weight |
| Sodium dodecyl hydrogen sulphate | 3.0% by weight |

This erasable ink does not leave any traces on the surface of the display and thus also carries out a cleaning function.

The advantage of the solution described in the FIGURE is that commercially available writing implements do not have to be modified to implement the use of the invention.

### LIST OF REFERENCE NUMERALS

1 input device
   10 application device
      101 pen
      102 end stopper
      103 application element
      105 application medium
      107 reservoir system
   20 end cap

1-4. (canceled)

5. An input device for touch-sensitive, capacitive surfaces, wherein the device comprises: a barrel; and at least one application element, wherein the device is configured as a pen filled with a liquid application medium that is electrically conductive, wherein the barrel is electrically non-conductive at least in a gripping region, and wherein an electrically conductive connection is provided between the at least one application element and the liquid application medium.

6. The device as claimed in claim 5, wherein the liquid application medium is present in the pen as free liquid.

7. The device as claimed in claim 5, wherein the liquid application medium is present in a reservoir system as a capillary action liquid.

8. The device as claimed in claim 5, wherein the application element is configured as a contacting element.
